(19) United States
(12) Patent Application Publication
(10) Pub. No.: US 2014/0237002 A1
(43) Pub. Date: Aug. 21, 2014

(54) SYSTEM HAVING A DATABASE UNIT AND TWO PROCESS APPLICATIONS EXECUTED ON MOBILE DEVICES

(71) Applicant: Alexandra Winkler-Teufel, Balgheim (DE)

(72) Inventor: Alexandra Winkler-Teufel, Balgheim (DE)

(73) Assignee: AppByYou GmbH, Balgheim (DE)

(21) Appl. No.: 14/241,212

(22) PCT Filed: Aug. 26, 2011
(86) PCT No.: PCT/EP2011/004274

§ 371 Date: Apr. 23, 2014

(51) Int. Cl. G06F 17/30

(52) U.S. Cl. CPC G06F 17/30289
USPC 707/802

(57) ABSTRACT

The invention is based on a system (10) having a database unit (12), which is at least intended to manage data (14) relating to at least one business process, and having at least one mobile computation unit (16, 18) which has a first process application (20, 22) which is intended to process data (14) relating to the business process. It is proposed that the system comprises at least one second process application (20, 22) which is intended to initiate a process step (24) of the business process at least in the first process application (20, 22).

### STATE OF THE ART

A system has already been proposed, having a database unit that is at least intended to manage data of at least one business process, and having at least one mobile calculation unit that has a first process application that is intended to process data of the business process.

### ADVANTAGES OF THE INVENTION

The invention proceeds from a system having a database unit that is at least intended to manage data of at least one business process, and having at least one mobile calculation unit that has a first process application that is intended to process data of the business process.

It is proposed that the system comprises at least one second process application that is intended to initiate a process step of the business process, at least in the first process application. A “database unit” should particularly be understood to be a unit that receives, stores, and outputs logically related data during operation. Preferably, the database has an interface that is intended to communicate with a great number of remote devices, particularly a great number of mobile calculation units. In particular, a “great number” should be understood to mean more than ten. “Intended” should particularly be understood to mean specially programmed, designed and/or equipped. The expression “data of at least one business process” should particularly be understood to mean data that describe a business process that appears practical to a person skilled in the art, but advantageously a stream of goods, a flow of money and/or a work process. “Manage” should particularly be understood to mean that the database unit is intended to change and/or output the data of the business process in a manner that appears practical to a person skilled in the art, but advantageously to change, search and/or output the data in compiled manner, in accordance with a request of the remote device. A “calculation unit” should particularly be understood to be a unit having data input, data processing, and data output. Advantageously, the calculation unit has at least a processor, a memory, input and output means, further electrical components, an operating program and/or calculation routines. Preferably, the components of the calculation unit are disposed in a common housing. In particular, a “mobile unit” should be understood to be a unit that is configured to be movable by an operator during communication with the database unit. Preferably, the mobile calculation unit has a communication means that communicates, particularly wirelessly, at least with the database unit during operation. Preferably, the mobile calculation unit is configured as a unit that appears practical to a person skilled in the art, but advantageously as a notebook, as a hand-held computer, as a mobile telephone, as a tablet PC and/or, particularly advantageously, as a smartphone. A “process application” should particularly be understood to be a function that is intended to output at least data of the business process to the operator and/or to record new data as well as changes in data from the operator. Preferably, the process application is intended to output data on a display of the mobile calculation units. Furthermore, it is advantageous if the process application is intended to record data from an operator, by means of an input unit of the mobile calculation units. Preferably, the second process application has at least one interface that sends at least one process message to the first process application to initiate the process step of the business process of the first process application. In particular, “process” should be understood to mean that the mobile calculation unit initiates a change in the data of the business process in the database unit. In particular, a “process step of the business process” should be understood to mean a procedure during which the mobile calculation unit at least calls up data of the business process from the database unit and advantageously causes a change in data of the business process to be made in the database unit. Advantageously, the second process application at least causes the first process application to display a request to the operator of the process application, which requests the operator to perform the process step of the business process. For example, the process step could be handling of an incoming order, compiling of goods, goods shipping, handling of a payment procedure and/or another process step that appears practical to a person skilled in the art. In this connection, “initiate” should particularly be understood to mean that the second process application initializes the process step of the business process. By means of the configuration of the system according to the invention, an individual complicated process application can be divided up into many small process applications, to manage the business process, and thereby can be optimized for use on a mobile calculation unit. In particular, particularly comprehensive business processes can be managed, in particularly advantageous manner, by multiple mobile operators.

In another embodiment, it is proposed that the system comprises a second mobile calculation unit that has the second process application, thereby making simple cooperation of spatially separate operators possible. Preferably, the system has more than two mobile calculation units, each having at least one process application for managing the business process.

Furthermore, it is proposed that the first process application and the second process application are configured separate from one another, thereby making particularly simple development and advantageous installation possible. The expression “configured separate from one another” should particularly be understood to mean that each of the process applications can be executed without the other process application, in each instance.

Furthermore, it is proposed that the mobile calculation unit has at least one memory means that stores at least a part of the data of the business process of the database unit at least in one operating state, thereby making particularly rapid access to the data of the business process possible in technically simple manner. Furthermore, use of the process application is possible at any time, without a permanent communication connection between the mobile calculation unit and the database unit. A “memory means” should be understood to mean, in particular, a digital memory that appears practical to a person skilled in the art, but advantageously a hard disk memory, a volatile memory and/or advantageously a flash memory. Preferably, the part of the data of the business process that are stored in the database unit and in the memory means are at least essentially the same, in other words by more than 75%, in at least one operating state. In particular, the part of the data of the business process is larger than 1 megabyte, advantageously larger than 10 megabytes, particularly advantageously larger than 100 megabytes. Preferably, the memory means stores all the data of the business process for which the process application has use. In particular, the memory means stores the data of the business process also before and after a change in the data; this means particularly that the memory means does not just store the data of the business process temporarily, for immediate processing.

Furthermore, it is proposed that the mobile calculation unit has a communication function that is intended to synchronize at least a part of the data of the business process in the database unit with data of the business process in the memory means, thereby advantageously making it possible to avoid collisions, if multiple process applications are using data of the business process at the same time. In particular, “communication function” should be understood to be a function that is intended to communicate at least with the database unit and with the process applications. In particular, the term “synchronize” should be understood to mean that changes in the data of the business process are transmitted from the mobile calculation unit to the database unit and from the database unit to the mobile calculation unit.

Furthermore, it is proposed that the process applications are intended to change data of the business process in a memory means, particularly by way of the communication function, thereby making particularly simple and reliable handling of the business process by operators possible.

In an advantageous embodiment of the invention, it is proposed that the communication function is intended to make data of the business process available to the process applications independent of availability of communication with the database unit, thereby making it possible to achieve particularly advantageous use with great availability. In particular, the expression “independent of availability” should be understood to mean that the process applications can access data of the business process even when a connection to the database unit is temporarily interrupted.

Furthermore, it is proposed that the database unit has at least one relational database that manages the data of the at least one business process, thereby making it possible to achieve particularly simple and flexible handling of the data. In particular, a “relational database” should be understood to be a database in which relations between the data sets of the database are described in the data sets themselves. Preferably, the database is configured as an SAP database.

Furthermore it is proposed that the database unit has at least one control application that, in the case of at least one change in the data of the business process, transmits at least the change to the mobile calculation unit, thereby making it possible for the process applications to advantageously access current data. A “control application” should particularly be understood to be an application that is at least intended to control access to the database unit. Preferably, the control application allows only authorized mobile calculation units to have access to the data of the business process. Preferably, the control application encrypts communication with the mobile calculation units. Particularly advantageously, the control application recognizes collisions of changes in the data of the business process that it receives from the mobile calculation unit and, in particular, from at least two mobile calculation units and/or process applications.

Furthermore, it is proposed that at least the control application and, in particular, the communication function is intended to synchronize the data of the business process after a communication interruption, thereby making it possible to recognize conflicts and advantageously access current data after a communication interruption.

Furthermore, it is proposed that the process application is intended to output data of the business process to an operator, thereby making advantageous handling of the business process possible. The expression “output to an operator” should particularly be understood to mean that the process application is intended to output the data acoustically and/or advantageously optically, by way of a device of the mobile calculation unit, advantageously a screen, so as to be perceived by an operator.

In an advantageous embodiment of the invention, it is proposed that the process application is intended to pass data entries made by an operator on to the database unit, thereby making it possible for the business process to be handled by multiple operators. In particular, “data entry” should be understood to be a procedure in which the operator issues at least one datum to the process application, to influence the data.

### DRAWINGS

Further advantages are evident from the following drawing description. In the drawings, an exemplary embodiment of the invention is shown. The drawings, the description, and the claims contain numerous characteristics in combination. A person skilled in the art will also consider the characteristics individually, in practical manner, and will combine them to produce practical further combinations.

The drawings show:

FIG. 1 a system according to the invention, having a database unit and two mobile calculation units, and

FIG. 2 a method according to the invention, with the system from FIG. 1.

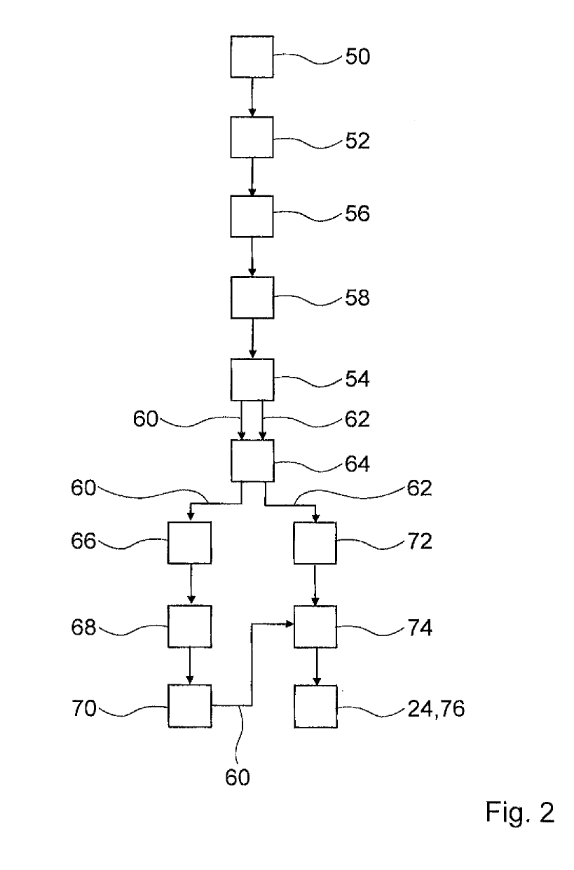

### DESCRIPTION OF THE EXEMPLARY EMBODIMENTS

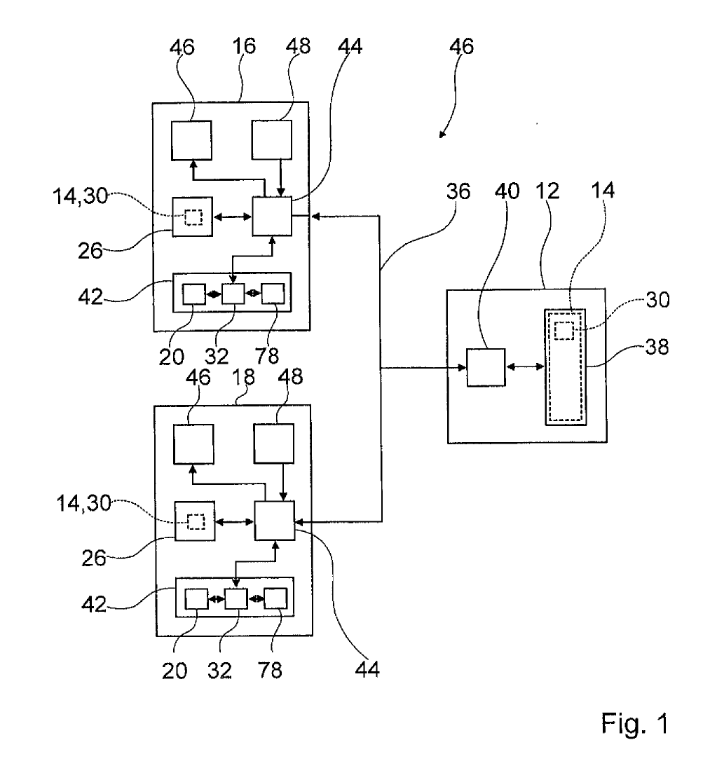

FIG. 1 shows a system 10 having a database unit 12, a first mobile calculation unit 16, and a second mobile calculation unit 18. The database unit 12 is configured as a server. The database unit 12 comprises a database 38 and a control application 40. The database 38 stores and manages data 14 of a business process. The database 38 is configured as a relational SAP database. In an operationally ready state, it stores data 14 of a business process. The control application 40 controls and monitors communication 36 of the database 38 with the mobile calculation units 16, 18. The database unit 12 and the mobile calculation units 16, 18 communicate by way of the Internet.

The first and the second mobile calculation unit 16, 18 are configured as portable tablet computers. They each have at least one process application 20, 22, a communication function 32, 34, a memory means 26, 28, a volatile RAM 42, a processor 44, a display 46, an input means 48, and, not shown in any detail here, a communication means. The communication means is intended to communicate with the Internet by way of a mobile phone network. The process applications 20, 22 and the communication functions 32, 34 are stored in the volatile RAM 42, at least in part, in an operationally ready state. Furthermore, the process applications 20, 22 and the communication functions 32, 34, not shown in any detail, are stored in the non-volatile memory means 26 in an operational state. The processor 44 executes the process applications 20, 22.

Furthermore, the memory means 26 stores data 14 of the business process. Here, the memory means 26, in an operationally ready state, stores a part 30 of the data 14 of the business process that the database unit 12 also stores. The communication functions 32, 34 synchronize the part 30 of the data 14 of the business process in the database unit 12 with the part 30 of the data 14 of the business process in the memory means 26, 28. It is dependent on the process applications 20, 22 present on the calculation units 16, 18 what part 30 of the data 14 of the business process the communications functions 32, 34 synchronizes with the database unit 12. Here, the communication function 32, 34, in each instance, synchronizes the part 30 of the data 14 of the business process that the process applications 20, 22 display and/or change. Thus, the parts 30 of the data 14 that the individual mobile calculation units 16, 18 store can be different. The part 30 of the data 14 of the business process that the mobile calculation units 16, 18 store has a great number of data sets, for example more than 1000 data sets. Thus, the communication functions 32, 34 make data 14 of the business process available to the process applications 20, 22 independent of any availability of communication 36 with the database unit 12.

The process applications 20, 22 are intended to process the part 30 of the data 14 of the business process. For this purpose, the process applications 20, 22 change data 14 of the business process in the memory means 26, 28, in each instance. In this connection, the process applications 20, 22 are configured separately from one another. Here, the process applications 20, 22 are installed on the different mobile calculation units 16, 18. The process applications 20, 22 can be installed and/or uninstalled on a single mobile calculation unit 16, 18, independent of one another. Two process applications 20, 22 installed on a mobile calculation unit 16, 18 communicate with a same communication function 32, 34.

After processing of the data 14 of the business process, the communication function 32, 34, in each instance, synchronizes the part 30 of the data 14 of the business process in the memory means 26, 28 with the part 30 of the data 14 of the business process in the database unit 12, specifically as soon as communication 36 between the mobile calculation units 16, 18 and the database unit 12 is possible. Alternatively or additionally, a mobile calculation unit could synchronize data when it is connected to a suitable network, for example upon return to a company domicile.

The control application 40 of the database unit 12 stores what part 30 of the data 14 of the business process the mobile calculation units 16, 18 store. If, for example, the first mobile calculation unit 16 transmits a change of data 14 of the business process to the control application 40 of the database unit 12, which change the second mobile calculation unit 18 stores, the control application 40 sends these changes to the second mobile calculation unit 18. If no communication 36 with the second mobile calculation unit 18 is possible at that time, the control application 40 sends the changes as soon as communication 36 is possible again. If the second mobile calculation unit 18 has changed the same data sets at that time, the control application 40 and/or the communication function 34 of the second mobile calculation unit 18 recognizes this collision. The process applications 20, 22 of the first mobile calculation unit 16 and of the second mobile calculation unit 18 display information concerning the collision to the operator, in each instance, thereby making it possible for the operators to resolve the collision individually or jointly. Thus, the communication functions 32, 34 and the control applications 40 are intended to synchronize the data 14 of the business process after a communication interruption.

The process applications 20, 22 output the data 14 of the business process to the operators by means of the display 46 of the mobile calculation units 16, 18. Furthermore, the process applications 20, 22 pass data entries made by the operators, using the input means 48, on to the database unit 12.

In a first method step 50, the communication functions 32, 34 are installed on the mobile calculation units 16, 18. In this connection, the communication functions 32, 34 are configured, that means particularly assigned to an identity of the operators of the mobile calculation units 16, 18. In a next method step 52, the process applications 20, 22 are installed on the mobile calculation units 16, 18. The process applications 20, 22 are assigned to a process step 24, 54, in each instance. During the installation, the process applications 20, 22 are configured, which means particularly assigned to a communication function 32, 34, and, if the business process provides for this, a subsequent process step 24 of the business process is established. During a further method step 56, the process applications 20, 22 report to the communication functions 32, 34, in each instance. In this connection, the communication functions 32, 34 store what part 30 of the data 14 of the business process the process applications 20, 22 require, in each instance. During a subsequent method step 58, the database unit 12 transmits the part 30 of the data 14, in each instance, to the mobile calculation units 16, 18, upon request from the communication functions 32, 34.

When the operator processes the process step 52 of the second process application 22, he changes a data set of the part 30 of the data 14 of the business process when doing so, in the case shown. The second process application 22 transmits these changes 60 to the second communication function 34. Furthermore, the second process application 22 sends a process message 62, by way of the communication function 34, to the process application 20, to which the subsequent process step 24 is assigned. The communication function 34, in a subsequent method step 64, passes this process message 62 on to the first process application 20 here. The process message 62 is configured as a WAP push message. Furthermore, the communication function 34 writes the changes 60 into the memory means 28 of the second mobile calculation unit 18. Furthermore, the communication function 34 sends the changes 60 to the database unit 12.

In a further method step 66, the control application 40 of the database unit 12 checks whether a collision with another change occurs as the result of the change. If this is not the case, the control application 40 stores the changes 60 in the database 38 in a method step 68. Subsequently, the control application 40 determines, in a method step 68, with what mobile calculation units 16 the changed data set of the data 14 of the business process must be synchronized. In a further method step 70, the control application 40 transmits the changes 60 to the determined mobile calculation units 16.

Reception 72 of the process message 62 initiates the next process step 24 of the business process in the first mobile calculation unit 16. The process message 62 has a datum that states whether synchronization of data 14 is required for processing of process step 24. In the next method step 74, the first process application 20 waits for reception of the changes 60 from the database unit 12, if applicable. By means of different transmission of the changes 60 and of the process message 62, a particularly high level of security and stability of the processing of the business process, particularly in the event of a disruption of the database unit 12, can be achieved. Alternatively, a process message could also be transmitted to the mobile calculation units 16, 18 by way of the database unit 12. After reception of the changes 60, the first process application 20 displays to the operator, in a subsequent method step 76, that an entry is required to process the process step 24 of the first process application 20. The process applications 20, 22 can also initiate a process step of the business process on a process application 78, which is installed on the same mobile calculation unit 16, 18.

### REFERENCE SYMBOLS

10 system

12 database unit

14 data

16 mobile calculation unit

18 mobile calculation unit

20 process application

22 process application

24 process step

26 memory means

28 memory means

30 part of the data

32 communication function

34 communication function

36 communication

38 database

40 control application

42 RAM

44 processor

46 display

48 input means

50 method step

52 method step

54 process step

56 method step

58 method step

60 change

62 process message

64 method step

66 method step

68 method step

70 method step

72 reception

74 method step

76 method step

78 process application

1. System having a database unit (12) that is at least intended to manage data (14) of at least one business process, and having at least one mobile calculation unit (16, 18) that has a first process application (20, 22) that is intended to process data (14) of the business process, comprising
at least one second process application (20, 22) that is intended to initiate a process step (24) of the business process, at least in the first process application (20, 22).

2. System according to claim 1, further comprising
a second mobile calculation unit (18) that has the second process application (22).

3. System according to claim 1, wherein
the first process application (20) and the second process application (22) are configured separately from one another.

4. System according to claim 1, wherein
the mobile calculation unit (16, 18) has at least one memory means (26, 28) that stores at least a part (30) of the data (14) of the business process of the database unit (12) in at least one operationally ready state.

5. System according to claim 4, wherein
the mobile calculation unit (16, 18) has a communication function (32, 34) that is intended to synchronize at least the part (30) of the data (14) of the business process in the database unit (12) with data (14) of the business process in the memory means (26, 28).

6. System according to claim 4,
wherein
the process applications (20, 22) are intended to change data (14) of the business process in the memory means (26, 28).

7. System according to claim 5,
wherein
the communication function (32, 34) is intended to make data (14) of the business process available to the process application (20, 22), independent of any availability of communication (36) with the database unit (12).

8. System according to claim 1, wherein
the database unit (12) has at least one relational database (38) that manages the data (14) of the at least one business process.

9. System according to claim 1, wherein
the database unit (12) has at least one control application (40) that, in the case of at least one change in the data (14) of the business process, sends the change to the mobile calculation unit (16, 18).

10. System according to claim 1, wherein
at least the control application (40) is intended to synchronize the data (14) of the business process after a communication interruption.

11. System according to claim 1, wherein
the process application (20, 22) is intended to output data (14) of the business process to an operator.

12. System according to claim 1, wherein
the process application (20, 22) is intended to pass on data entries made by an operator to the database unit (12).

13. Mobile calculation unit according to claim 1.

14. Method having a system (10), according to claim 1,
which manages a database unit (12) that manages the data (14) of at least one business process, and at least one mobile calculation unit (16, 18) having a first process application (20), which processes data (14) of the business process, further comprising
a second process application (22) that initiates a process step (24) of the business process at least in the first process application (20).
